(19) United States
(12) Patent Application Publication
(10) Pub. No.: US 2011/0017544 A1
(43) Pub. Date: Jan. 27, 2011

(54) ACOUSTIC DAMPENING ENCLOSURE FOR A MECHANICAL DEVICE

(75) Inventors: Jesse T. Bodwell, Manchester, NH (US); James D. Dale, Nashua, NH (US)

Correspondence Address: Michelle Saquet Temple, DEKA Research & Development Corp., 340 Commercial Street, Manchester, NH, 03101-1129, US

(73) Assignee: DEKA Products Limited Partnership, Manchester, NH (US)

(21) Appl. No.: 12/840,866

(22) Filed: Jul. 21, 2010

Related U.S. Application Data
(60) Provisional application No. 61/227,220, filed on Jul. 21, 2009.

(51) Int. Cl. G10K 11/16

(52) U.S. Cl. 181/200

(57) ABSTRACT

A two-component elastomeric enclosure surrounding a mechanical device can effectively attenuate the noise and vibration associated with the device. The outer shell of the enclosure comprises a castable polyurethane elastomer, while the inner shell of the enclosure comprises polymeric foam. The inner foam layer of the enclosure can contact both vertical and horizontal surfaces of the enclosed device in order to immobilize it within the enclosure, and to enhance the dampening effect of the enclosure on acoustic and mechanical vibrations. The enclosure can act as a vertical and horizontal supporting structure for the enclosed mechanical device. The enclosure may in turn be fastenable to a housing or frame member via relatively stiff elastomeric bushings, pads or mounts, in order to further reduce the transmission of vibrations originating from the mechanical device. The enclosure can be molded in a two-stage pour-molding process using a cavity mold and two forming dies—one for each layer of the enclosure. The second stage of the molding process allows the inner foam layer to bond to the outer shell of the enclosure during the curing process, and to have inner dimensions that can make close contact with pre-determined portions of the device for which the enclosure is being produced. Highly customized cavity molds and forming dies can be created using rapid manufacturing or prototyping techniques.

### RELATED APPLICATIONS

The present application claims priority to U.S. Provisional Application No. 61/227,220 filed on Jul. 21, 2009 and entitled Acoustic Dampening Enclosure for a Machine, the entire contents of which are incorporated herein by reference.

### FIELD OF THE INVENTION

The present invention relates generally to enclosures for dampening the noise and mechanical vibration associated with mechanical devices, and in one embodiment to a noise- and vibration-suppressing enclosure for miniature pumps.

### BACKGROUND

The present invention relates to the control of noise and mechanical vibration associated with certain machines. Machines operating with compressed air, vacuum, or pressurized liquid, for example, use pumps that can create substantial amounts of noise and vibration. Dimensional constraints may make it particularly challenging to suppress the noise and vibration of a portable or compact machine. Noise reduction is an important goal in the design of certain medical devices, because in many cases they must be operated close to the patients they serve. Examples include portable fluid pumps for intravenous or intra-cavitary use, extracorporeal circulatory systems, as well as hemodialysis and peritoneal dialysis machines, among others. Some of these devices may be equipped with pneumatically-actuated membrane pumps and valves, or other mechanical assemblies that need to generate, maintain or use a continuous source of compressed air, vacuum, or pressurized liquid.

Miniature hydraulic or pneumatic pumps, such as, for example, the Hargraves BTC-IIS Single Body Dual Head Miniature Diaphragm Pump and Compressor, are well-suited for compact medical devices such as automated or portable peritoneal dialysis machines. However, home-based automated peritoneal dialysis is often preferably performed at night during sleep. Thus it would be particularly desirable to be able to mitigate the noise and vibration associated with pumps of this type.

It is possible to substantially reduce the noise and vibration associated with machines using pumps—or indeed any

noisy mechanical devices—by surrounding the mechanical device with an insulating enclosure. However, the enclosure should neither occupy an excessive amount of space, nor substantially affect the performance or longevity of the enclosed mechanical device. A mechanical device such as a pump should be allowed to dissipate some of the heat it generates during use, and it may need to have access to ambient air for proper operation. It would also be desirable for the insulating enclosure to help suppress the transmission of mechanical vibrations associated with the enclosed mechanical device. It would be even more desirable for the insulating enclosure to provide structural support for the enclosed mechanical device, in order to avoid having to secure the mechanical device directly to a surrounding housing member or a frame member (e.g. by contact between metal or plastic housings, or by the use of metal or other rigid fasteners), thus further reducing the possibility of transmitting mechanical vibrations externally to an associated machine.

### BRIEF DESCRIPTION OF THE DRAWINGS

FIG. 1 is a perspective view of an illustration of an exemplary enclosure for a miniature pump module;

FIG. 2 is an exploded view of the enclosure and enclosed pump module depicted in FIG. 1;

FIG. 3 is an illustration of an exemplary heat sink mounted on the exposed motor housing of a pump module within an enclosure;

FIG. 4 is a top view of the enclosure shown in FIG. 1

FIG. 4a is a sectional view an enclosure, taken along section A-A of the pump enclosure of FIG. 4;

FIG. 4b is a sectional view of an enclosure fastener, taken along section B-B of the pump enclosure shown in FIG. 4;

FIG. 5 is a perspective view of a cavity mold and forming die for the enclosure of FIG. 1;

FIG. 6 is a cross-sectional view of the assembly of FIG. 5, with the forming die separated from the cavity mold;

FIG. 7 is a cross-sectional view of the forming die of FIG. 6 mated to the cavity mold of FIG. 6;

FIG. 8 is a cross-sectional view of the of the cavity mold of FIG. 6, containing a first molded part, and a second forming die situated above the cavity mold;

FIG. 9 is a cross-sectional view of the forming die of FIG. 8 mated to the cavity mold of FIG. 8;

FIG. 10 is a cross-sectional view of a completed molded part, separated from and above the cavity mold of FIG. 8.

### DESCRIPTION OF THE PREFERRED EMBODIMENTS

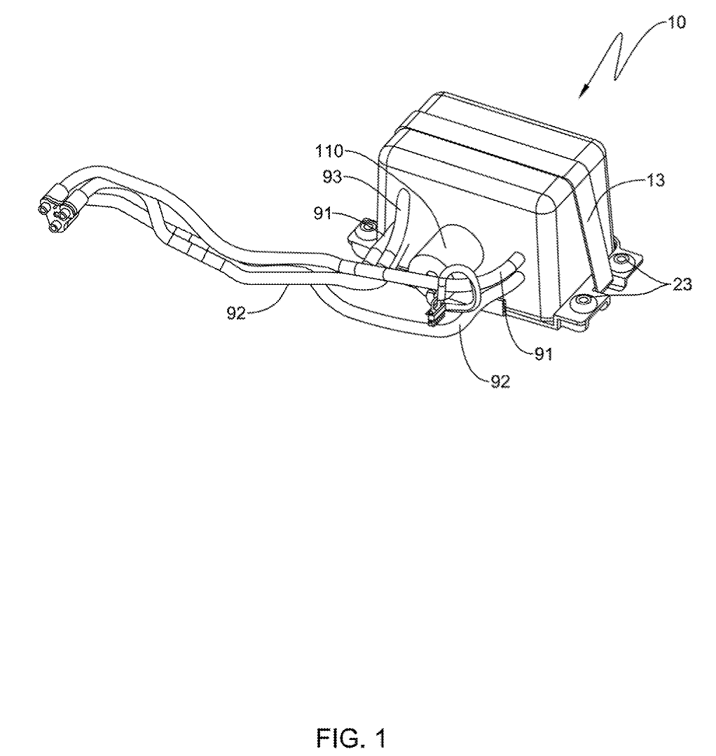

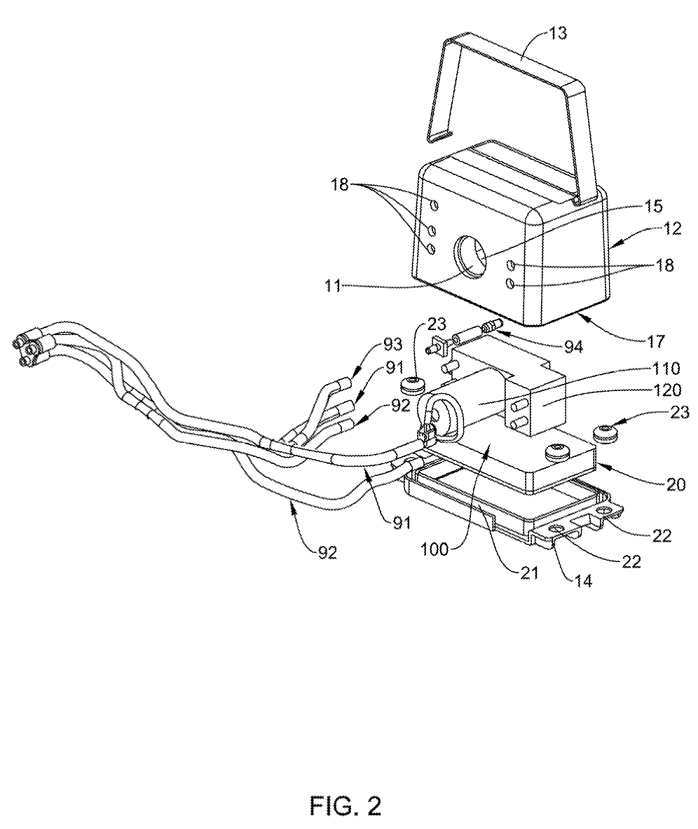

As shown in FIGS. 1 and 2, a sound and vibration dampening enclosure 10 can be of a size and shape to enclose a noise-generating mechanical device. In certain embodiments, the enclosure 10 can be made to surround only the noisiest components of the enclosed device. In an embodiment, one or more internal surfaces of the enclosure can make contact with one or more portions of the device to absorb vibration as well as noise, and in some aspects to physically secure the device within enclosure 10. In one aspect the device need not be directly fastened to a frame member or a housing member of a machine within which the device is located. Although the invention can be adapted to any enclosable mechanical device for which noise and/or vibration abatement is desired, for purposes of illustration, the following description will largely refer to a pump module comprising a motor and a pump.

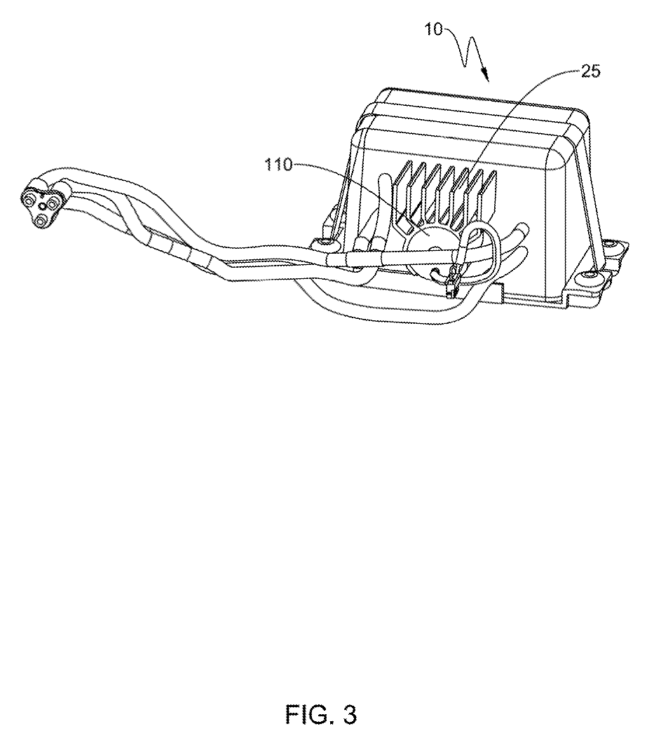

As shown in FIG. 2, a pump module 100 comprising a pump housing 120 and motor housing 110 can be at least partially or completely enclosed within enclosure 10. In an embodiment, enclosure 10 has an opening 15 to allow one end of motor housing 110 to protrude from enclosure 10, to assist in conducting heat generated by pump module 100 to the environment outside enclosure 10. As shown in FIG. 3, a heat sink 25 can be installed on the exposed portion of pump motor housing 110 to assist in dissipating the heat generated by pump module 100. Heat sink 25 can be manufactured from any material suitable for conducting heat, such as, for example, aluminum, copper or steel. Heat sink 25 can function more effectively if the environment surrounding pump enclosure 10 can remain at a temperature significantly lower than the temperature within the enclosure. This can be achieved, for example, by installing a cooling fan to circulate air from an external environment (e.g., outside the device in which pump module 100 is installed) into the area surrounding heat sink 25. Preferably, enclosure 10 completely encloses pump housing 120, because in many cases, pump components within pump housing 120 tend to be responsible for the greatest amount of noise produced by pump module 100 during operation. In an embodiment, the enclosure 10 is formed as a single molded piece, with one open side 17 (as shown in FIG. 2) to allow access to the pump module 100. Holes 15 and 18 may be punched, drilled or cut into one or more sides of the enclosure 10 to accommodate cabling, inlet 91 and outlet 92 tubes, as well as any portion of the motor housing 110 that is to remain outside of the enclosure 10.

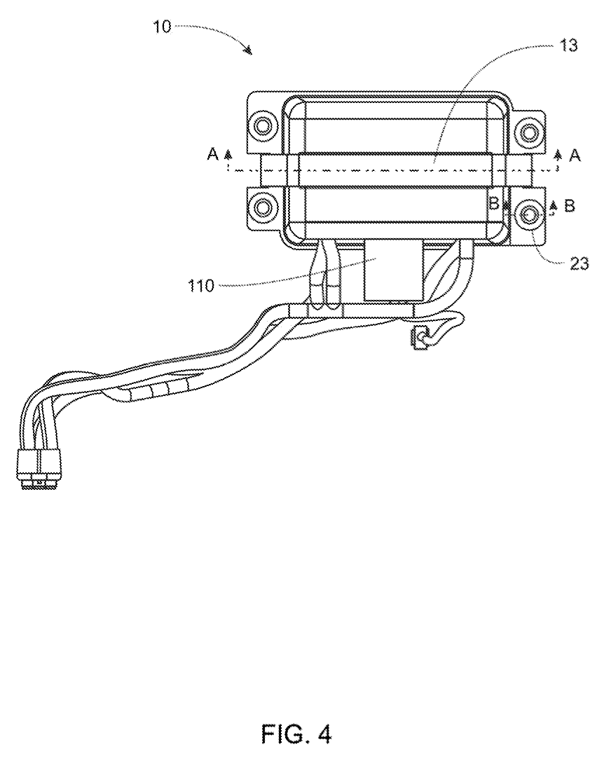

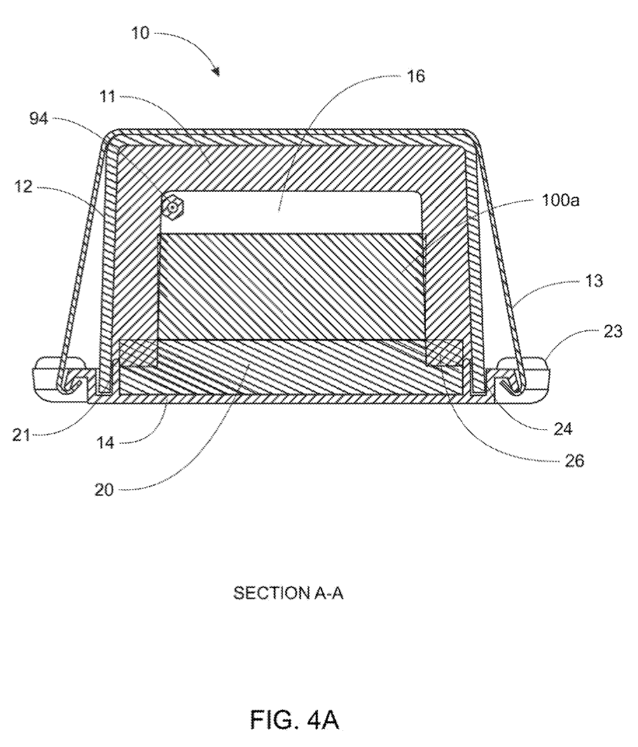

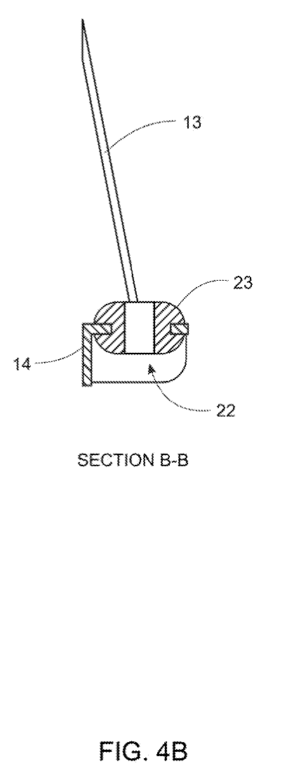

The enclosure 10 can be constructed of two polymer-based synthetic sound and vibration dampening materials, one nested within the other. As shown in FIG. 4a, an inner shell 11 can be composed of a low density, relatively soft and resilient polymeric foam, such as polyurethane or PVC foam, which has been molded to generally conform to and contact the inner surfaces of an outer shell 12. The outer shell 12 can be composed of a semi-rigid, flexible or elastomeric compound, such as a thermoset polyurethane elastomer.

The inner shell 11 material can be open or closed cell foam. The open cell foam may be less costly, and may have greater thermal conductive properties, which favors heat dissipation. In some cases, open cell foam may also have a greater ability to act as a sound barrier. In an embodiment, one or more of the inner surfaces of inner layer 11 can make contact with at least some of the outer surfaces of the enclosed mechanical components, such as a pump housing 120 or motor housing 110. In this case, a material made of closed cell foam may provide greater rigidity and strength, helping to physically secure an enclosed mechanical device, such as pump module 100, within enclosure 10, which in turn can be secured to a frame or housing member of a machine within which the mechanical device is located. Physical contact between the inner surfaces of inner shell 11 and the floor and at least some sides of an enclosed mechanical device may also enhance the suppression of mechanical vibration. In a preferred embodiment, the inner shell 11 of the enclosure 10 has the property of absorbing rather than reflecting pump- and motor-generated sound and vibration. The synthetic foam is preferably sufficiently resilient to be elastically compressible by at least some portions of the pump housing 120 and motor housing 110, so that structural support for the pump module 100 can be transferred to the stiffer outer shell 12.

Preferably, the inner foam shell 11 is bonded chemically or through an adhesive to the inner surfaces of the outer shell 12, to provide more secure structural support for an enclosed mechanical device, and to improve the acoustic and mechanical dampening effect of the enclosure 10. In an embodiment, the bonding between the inner foam material and the outer shell occurs during the curing process of the inner polymeric foam layer. Alternatively, after it has cured, the inner foam shell may be secured to the outer shell by an adhesive or other means. In other cases, it may simply make contact with the outer shell without adhering to it. However, having the inner 11 and outer 12 shells permanently in contact with one another may help reduce the transmission of vibration that may otherwise occur if each layer can move separately.

In a preferred embodiment, as shown in FIG. 4a (a sectional view A-A of enclosure 10 shown in FIG. 4), enclosure 10 has a relatively high density outer insulating shell 12 adjacent a lower density inner synthetic foam shell 11. The higher density of shell 12 may help to reflect sound and vibration that manages to penetrate the inner shell 11. Transmission of sound and vibration outside of enclosure 10 may thereby be reduced. The elastomeric properties of shell 12 additionally may help to absorb mechanical vibration. Shell 12 can function as a semi-rigid shell to allow enclosure 10 to be secured to an outer structure by fasteners such as, for example, metal clips and/or retention straps 13 onto a base plate 14, or otherwise within a frame or housing assembly. The elastomeric properties of shell 12 also provide a degree of resilience or an elastic counter-force against any retaining fastener, further reducing the transmission of vibration of the enclosure against base plate 14 or other frame or housing member to which it is attached. Thus, shell 12 is resilient or stiff enough to restrain or even fully support an enclosed mechanical device, yet limp enough to absorb acoustic and mechanical vibrations. An enclosed mechanical device, such as pump module 100, occupies a space 100a within the enclosure, and makes contact at least with a base panel 20. Preferably, one or more additional sides of the enclosed mechanical device makes contact with inner shell 11 to provide a more secure lateral as well as vertical fixation of the mechanical device within enclosure 10.

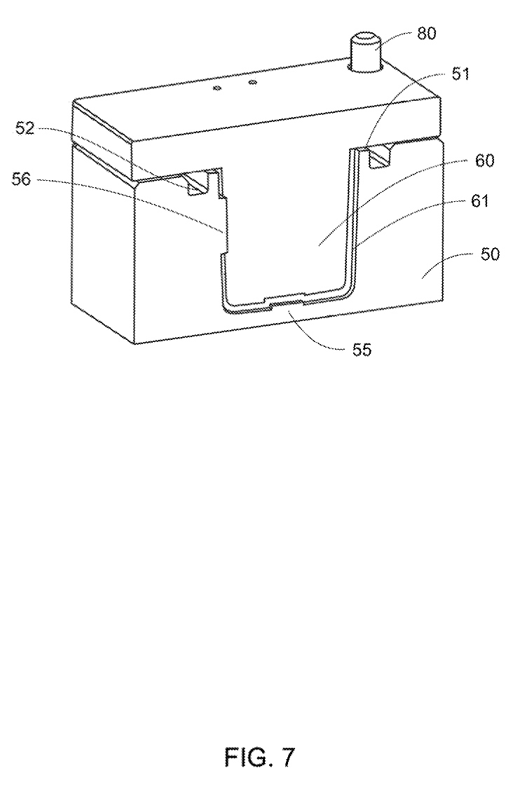

A base panel 20 can be used to complete the enclosure of the mechanical device after it has been installed through the opening of enclosure 10 that the base panel 20 covers. The base panel 20 in one embodiment can be constructed of a two-layer material similar to that of the pump enclosure 10. In another embodiment, the base panel 20 may have an inner synthetic foam layer similar to the inner layer of the enclosure, but have an outer shell comprising a more rigid plastic or metal plate in order to increase the rigidity and strength of the attachment of the enclosure 10 and pump module 100 to an external support or housing member. Alternatively, the inner surface of a rigid base plate 14 can be lined with the same two-layer foam/elastomeric material as the enclosure 10 itself, secured to the rigid base plate 14 by an adhesive, tape or other suitable material. The perimeter of the inner surface of the base plate 14 can have a flange and recess forming a track 21 to allow the exposed ends of the walls of the enclosure 10 to fit securely onto base plate 14. In the illustrated embodiment, a flange of the outer shell 12, created by overflow of the thermoset polyurethane material into an overflow channel 52 (shown in FIG. 7) has been trimmed off to allow the walls of enclosure 10 to terminate straight within base plate track 21. The base plate track 21 can be constructed to provide a snug fit over the ends of the walls of the outer shell 12 of enclosure 10. The insertion of the ends of the outer shell 12 of the enclosure 10 into the base plate track 21 helps to seal the enclosure as well as to provide it with lateral stability. In one embodiment, the polymeric foam comprising both the inner shell 11 and the base panel 20 is sufficiently compressible to allow for compression sealing of the joint zone 26 between inner shell 11 and base panel 20. In another embodiment, it may be preferable to allow some tolerance of the fit between the assembled parts to ensure that the enclosure 10 can ‘breathe’ to obtain a desired air leakage rate for a pump module that is vented within the enclosure 10. A gap 24 between the ends of outer shell 12 and track 21 can provide the necessary space to permit the desired air leakage rate. The tightness with which mounting clip or metal band 13 secures enclosure 10 can help to determine the air leak rate through gap 24. The base panel 20 and base plate 14 can be secured to the enclosure 10 by a mounting clip or metal band 13, or snap band, plastic tie, circumferential tape, or any other suitable means. The base panel 20 can provide access to the pump module 100 within the enclosure 10, as well as a means for the enclosure 10 to be secured to a platform such as a base plate 14, which in turn can be secured to a support member or housing member. As shown in FIG. 2, a suitable number of holes 22 may be drilled into the perimeter of the base plate 14, for example, to fasten the base panel 20/enclosure 10 combination to an external support member or housing member by screws, bolts, rivets or other suitable fasteners. In order to provide additional dampening of vibration and noise that may be transmitted to a housing within which enclosure 10 is located, the fasteners can include, for example, elastomeric or rubber grommets 23 or isolation bushings, rubber pads, spring suspension mounts, among other similar assemblies. As shown in FIG. 4b, (a sectional view B-B of a fastener shown in FIG. 4), an elastomeric grommet 23 can be used to join base plate 14 to an underlying housing member or platform via hole 22, a screw or bolt being placed through the central hole of grommet 23 and into the underlying housing member or platform (not shown). Thus, mechanical vibrations transmitted through enclosure 10 to base plate 14 can be dampened by grommets 23, rather than being transmitted directly to the machine housing holding pump module 100 and enclosure 10.

In a pneumatic pump module 100, the pump air vent tube 93 (shown in FIGS. 1 and 2) may also be the source of a substantial amount of noise. Air may move in and out of the vent tube 93 or its attached filter/muffler 94 at relatively high velocity, and an attached filter/muffler 94 may be insufficient to dampen the noise generated by the pump 120. By virtue of the flexibility of enclosure 10, it may be feasible to construct a system of venting that can at least partially bypass vent tube 93. For example, as shown in FIG. 4a, the pump enclosure 10 may be constructed to allow an air volume 16 into which the pump module 100 can be vented. This air volume 16 may be adjacent to one aspect of the pump/motor housing within the enclosure 10, such as, for example, at the top of the pump module 100, or at the top of pump module space 100a. In one embodiment, ultimate venting to the outside of the enclosure 10 may occur either through a series of holes or slots made in one or more side walls near the base of the pump enclosure 10, or the enclosure 10 itself may be secured to the base plate 14 with enough tolerance to permit a definable amount of air leakage through the joint 24 formed between the ends of the side walls of the outer shell 12 of enclosure 10 and the base plate track 21.

Preferably, the openings 15, 18 (shown in FIG. 2) can be slightly undersized to provide a snug slip-fit or press-fit connection between the protruding components of pump module 100 and the surrounding elastomeric material of outer shell 12 and foam material of inner shell 11. In the exemplary embodiment, opening 15 is sized to allow the free end of pump motor 110 to protrude from enclosure 10. A snug fit has the advantage of providing some vibration dampening, as well as providing mechanical support for that portion of pump module 100. In this embodiment, smaller openings 18 provide for pump inlet 91, outlet 92 and venting 93 tubes. In a further aspect, the tightness of the fit between any opening in enclosure 10 and a protruding element can be maximized by sizing the opening in the inner shell 11 slightly tighter than the opening in the outer shell 12. This is possible because a polyurethane foam material is softer and has greater compressibility than the thermoset elastomeric material of outer shell 12.

The outer shell layer 12 is preferably constructed from a castable polyurethane elastomer, such as a thermoset or thermoplastic polyurethane elastomer, which can be processed in liquid form at high temperatures, and when cured has elastic properties and resists creep. In fully cured form, it has a semi-rigid consistency: flexible enough to be deformable and to dampen acoustic and mechanical vibration, yet rigid enough to be only modestly compressible and to be able to recover and maintain its cast shape. A thermoplastic elastomer can have greater resistance to deformation than more traditional rubber compounds. Thus, when molded to an appropriate shape, it may provide significant structural support, yet remain flexible enough to absorb mechanical and acoustic vibration.

In one example, the enclosure can be constructed from Barycast® sound barrier material produced by Blachford Inc. of West Chicago, Ill. A process of molding a thermoset polyurethane elastomer and bonding it with an inner polyurethane foam layer has been developed and marketed by Blachford Inc. Barycast® is an elastomeric material (a highly filled thermoset polyurethane elastomer) with sufficient rigidity to retain a shape that conforms to an enclosed object, yet is limp enough to effectively block sound transmission from the object. Barycast® with Cast-in-Place Foam is cast in a two-stage process, first forming and curing the outer shell, and then forming and curing a polyurethane foam adjacent the cured outer shell. In liquid form, this material can be vacuum, injection- or pour-molded, or extruded into the appropriate shape. Once the Barycast® outer layer has cured and solidified to a shell structure, a polyurethane foam layer can then be pour molded or injected onto the inner surface of the Barycast® layer. The foam inner shell can bond to the inner surface of the outer shell structure during the curing process.

The invention disclosed herein takes advantage of the materials and of the process outlined above to construct enclosures in a way that markedly improves their noise-reduction properties. In a novel application of the above-described material, the enclosures of the instant invention not only surround most of the mechanical component to be sound-insulated, but also serve as a structural support for the enclosed mechanical component in order to secure it to its external environment. In the exemplary case, the two-layer elastomer/foam material is formed in a mold constructed to ensure that one or more portions of the inner foam shell make direct contact with key portions of the housings of a miniature pump and motor, such as pump module 100. Movement of a device such as pump module 100 within the enclosure 10 can thus be constrained. In an embodiment, pump module 100 (or any other enclosed mechanical device) can be substantially immobilized within its enclosure. Thus, a pump module used to generate fluid pressure or vacuum in a portable machine such as a dialysis machine can be fully supported both vertically and horizontally by the enclosure, further minimizing the transmission of sound and mechanical vibration to the housing of the machine in which the pump module is situated. The result is an enclosure with markedly improved sound- and vibration-insulating properties, when compared to similar material that is essentially draped over the noise-generating device, or molded to less than fully enclose the device.

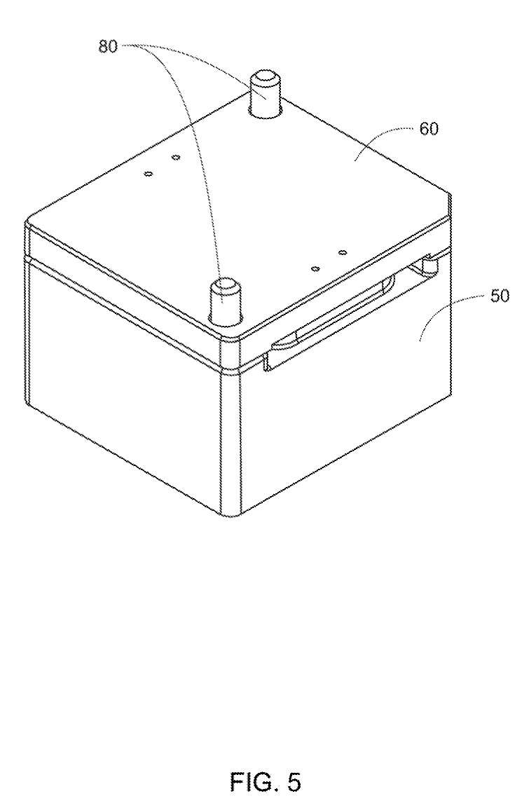

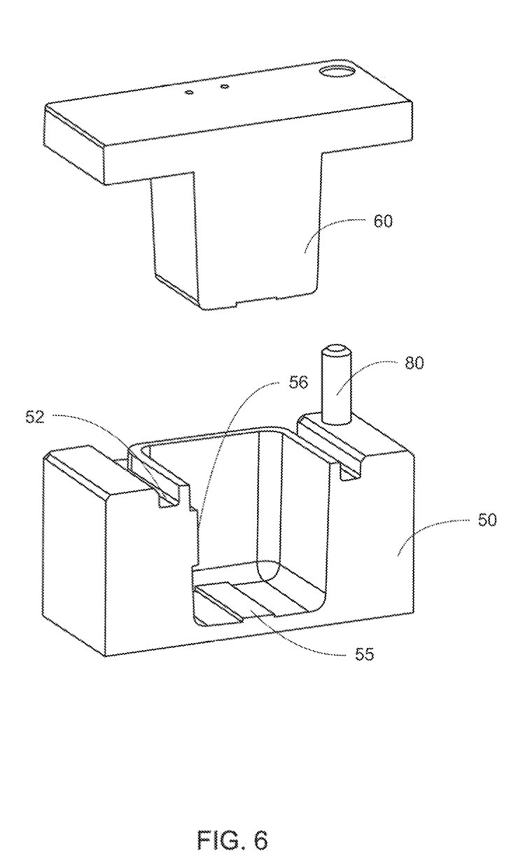

In one embodiment, the inner foam shell 11 can be molded onto the inner surface of the outer elastomeric shell 12 using a two-stage open mold pouring and/or extrusion process, or through an injection molding process. The first stage involves the formation of the outer elastomeric shell 12 of the enclosure 10, and the second stage involves the formation of the inner polyurethane foam shell 11 of the enclosure 10. As shown in FIG. 5, a cavity mold 50 and a first forming die 60 can be used first to form the outer layer elastomeric shell 12 of the enclosure 10. Alignment pins 80 can help to precisely align the top of die 60, and a subsequent second forming die 70 with the base cavity mold 50. A predetermined amount of the outer shell material in liquid phase can be poured into the cavity mold 50. As shown in a cross-sectional view of cavity mold 50 and die 60 in FIG. 6, a first forming die 60 can then be pressed into the cavity mold 50, the first forming die 60 generally conforming to the shape of the inner walls of the cavity mold 50, but being dimensionally smaller than the inner walls of the cavity mold 50 by an amount that corresponds to the planned thickness of the outer shell layer 12 of the enclosure 10.

As shown in FIG. 6, indenting features 55 and/or 56 can be built into cavity mold 50 in order to provide indentations or holes in the outer shell layer 12 being formed. For example, feature 55 can be of a thickness less than the gap formed between cavity mold 50 and first forming die 60 in order to create a small indentation or recess on the top of enclosure 10. Indenting feature 55 can be formed in the cavity mold 50 in an area corresponding to the top of the finished enclosure 10, which can serve as a recessed guide to accommodate a mounting clip or metal band 13 (shown, e.g., in FIGS. 1, 2 and 4) that can later be used to secure the enclosure to its base plate 14. Feature 56 can be of a thickness great enough to close the gap between cavity mold and forming die 60, creating a pre-positioned hole in the outer shell 12 to permit a component of an enclosed mechanical device to protrude through the enclosure 10 (such as, e.g., the free end of pump 110 of pump module 100, shown in FIG. 1). Preferably, as shown in the cross-sectional view of FIG. 7, the gap 61 between the cavity mold 50 and the first forming die 60 is generally uniform, creating an outer shell layer 12 of uniform thickness roughly equivalent to the width of gap 61.

As shown in FIG. 7, as the first forming die 60 is pressed into the cavity mold 50, excess liquid material is pressed out the perimeter of the top 51 of the cavity mold 50, and optionally into an overflow channel 52 recessed into the top portion of the cavity mold 50. This may help to form a flange of relatively uniform thickness along the opening of the elastomeric shell 12, and create a thin contact surface of elastomeric outer shell material to which a thin layer of the subsequent foam shell 11 can bond.

The formed outer shell 12 may then be allowed to cure to a solid phase, with or without the addition of a catalyst. The outer shell 12 can be removed from the cavity mold 50, and it can be trimmed as needed and its inner surface cleaned of any coating of mold release. The inner surface of shell 12 can then optionally be roughened to aid in the subsequent bonding of the inner foam layer 11. If the outer shell 12 was removed for the above preparatory steps, it may be reinstalled into the cavity mold 50. The cured shell material 12 can then be cut away from the overflow channel 52 to allow the channel 52 to be re-used in the second stage of the process.

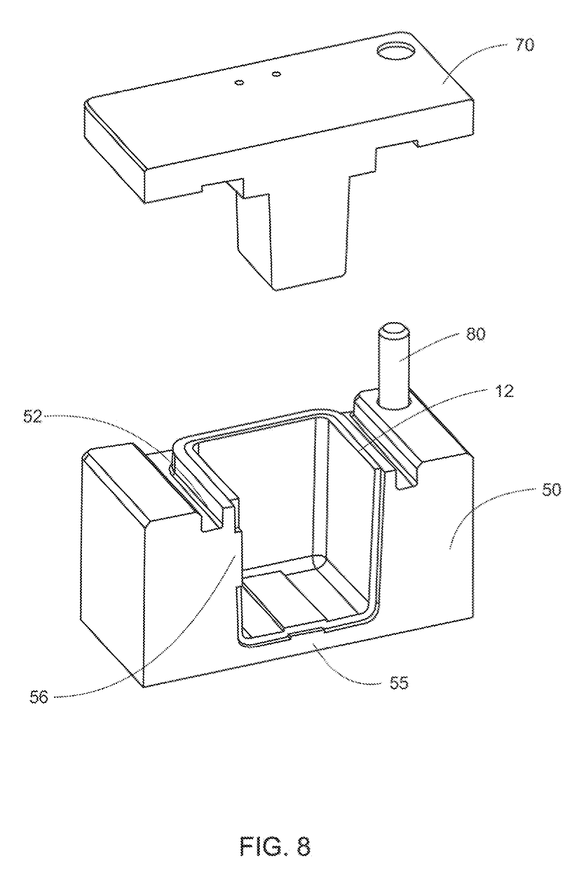

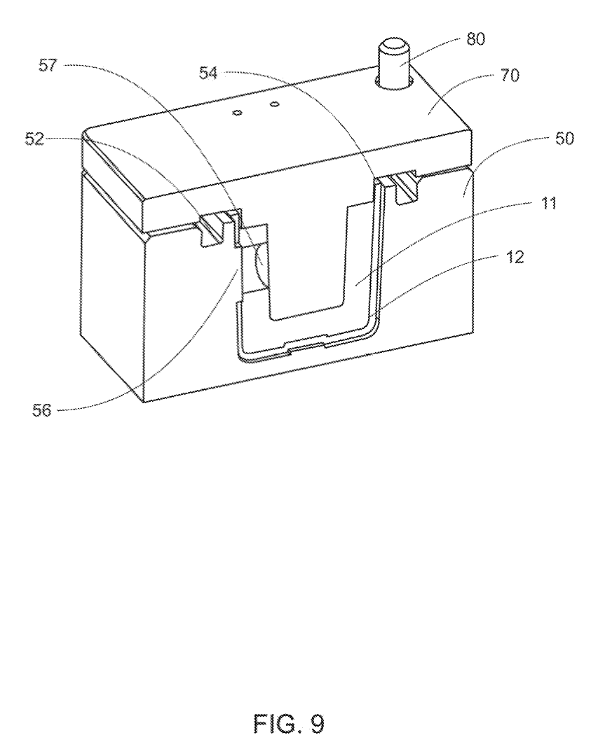

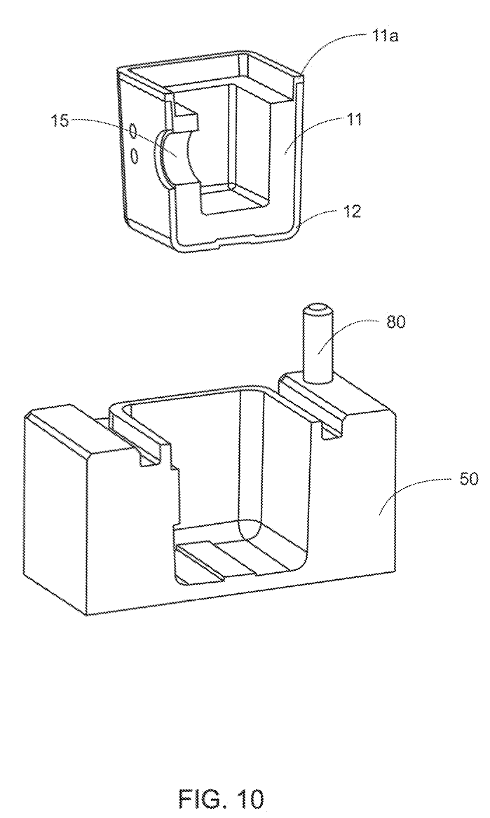

A liquid polyurethane foam precursor material may then be poured into the chamber consisting of the cavity mold 50 lined by the outer shell material 12, as shown in FIG. 8. A second dimensionally smaller forming die 70 can then used to form the inner foam layer 11. Alternatively, forming die 70 can be positioned in cavity mold 50 before pouring the foam precursor, and it may be injected into a closed space formed between the inner surfaces of outer shell 12 and forming die 70. The second forming die 70 can be made to generally follow the contours of the cavity mold 50 or conform to the shape of the first forming die 60 (and thus the internal shape of the outer shell 12), or it may have dimensions that allow the inner surface of the inner foam layer 11 to have a shape suitable for making contact at predetermined points or surfaces of the particular mechanical device to be enclosed (e.g., pump module 100). In a preferred embodiment, the sides of forming die 70 are shaped so that two or more sides of the mechanical device to be enclosed come into contact with the inner surface of the cured inner shell 11. The mechanical device can thus be laterally secured or stabilized within enclosure 10. For most applications, the second forming die 70 will have overall dimensions that cause the inner foam shell 11 to be thicker than the outer elastomeric shell 12, in order to optimize the sound absorbing qualities of the cured foam material. Turning to FIG. 9, the overflow channel 52 if present can accommodate any excess liquid foam precursor as it cures and expands, to maintain a uniform density and optionally to allow a polyurethane foam layer to be formed on the overflow flange of the elastomeric shell 12. A second gap 54, shown in FIG. 9, may optionally be larger than the gap used to form the overflow flange of the outer shell 12. This allows a thin layer of the inner foam material to pour over and bond to the outer shell overflow flange. Although the combined flange material may ultimately be trimmed away to square off the open ends of enclosure 10, the secondary gap 54 will have functioned to ensure that the polyurethane foam component extends to the very edge of the open ends of the enclosure 10, allowing the option of having some degree of ‘leakiness’ of the enclosure 10 to air when it is used to enclose a pump module, as described earlier. The additional layer 11a of polyurethane foam along the open edges of enclosure 10 is illustrated in FIG. 10.

After the first stage, as shown in FIG. 9, an insert 57 may optionally also be positioned in the cavity adjacent to the indenting feature 56 in order to continue the opening through the inner foam layer 11 of the enclosure 10. The insert 57 may be similar in size to the indentation 56, or it may differ in size or shape, as the particular enclosure being constructed may require. For example, the insert 57 may be slightly smaller than indenting feature 56, so that the inner foam shell 11 can provide a tighter fit around any element ultimately protruding through the opening thus formed. In an alternative embodiment, one or more holes 15 in the enclosure 10 can be made after the enclosure 10 has been formed and cured. In that case, it may be helpful to construct a shallower indentation 56 in order to create a slight impression in the side of the enclosure as it cures, to later act as a guide for any subsequent cutting or punching operation to make the final hole.

As the second forming die 70 is pressed into the cavity mold 50, the mechanical pressure generated helps the polyurethane foam precursor to thoroughly contact the inner surfaces of outer shell 12, preferably eliminating air pockets or voids between the two shell materials. The curing process may be triggered or hastened by the use of a liquid catalyst, during which the inner foam layer 11 may bond to the inner surface of the outer shell 12. As shown in FIG. 10, a preferred embodiment of pump enclosure 10 in its final cured form comprises an outer, relatively stiff elastomeric shell 12 that provides the structural stiffness to support the inner, relatively soft synthetic foam layer 11 to which it is bonded, the foam shell 11 being the component that actually makes contact with and secures an enclosed mechanical device such as pump module 100.

The second forming die 70 can also be constructed to allow an air space 16 of a pre-determined volume to exist over an enclosed mechanical device (such as, e.g., the pump module 100) within the enclosure 10 in order to accommodate any air volume that may be needed to supply or exhaust the pump (if such an option is desired), as shown in FIG. 4a.

In other embodiments, the liquid material for outer shell 12, and/or the liquid material for the inner foam layer 11, can be poured under pressure or injected into the gaps formed between the cavity mold 50 and the forming dies 60, 70. This can be accomplished, for example by incorporating injection channels (not shown) in the walls of the cavity mold 50 or the first forming die 60 to form the outer shell layer 12 of the enclosure 50, and/or by incorporating injection channels into the second forming die 70 to form the inner foam layer 11 of the enclosure 50.

Because of the many possible 3-dimensional configurations of pump assemblies (or of any mechanical device for which an enclosure is desired), it may be more efficient to use rapid manufacturing techniques to produce the cavity molds and forming dies. Once an enclosure destined for high-volume production has been successfully implemented and tested, it may then be appropriate to convert to full production tooling using materials less susceptible to wear. Some of the rapid manufacturing techniques can include, for example, selective laser sintering, fused deposition modeling, or stereo-lithography. An advantage of these techniques is that the internal dimensions of the molds and the external dimensions of the forming dies can be adjusted quickly and repeatedly until an optimal fit is obtained between the inner surfaces of the cured foam layer 11 of the enclosure 10 and the dimensions of the housing of the particular mechanical device being enclosed and supported. The materials used to generate the prototype dies can include acrylonitrile butadiene styrene (“ABS”), polycarbonates, polycaprolactone, polyphenylsulfones, and certain waxes. Many of these materials are structurally sufficiently robust when fully formed to withstand the mold pouring or injection processes used to manufacture the pump enclosure 10.

1. An acoustically insulating enclosure for a mechanical device comprising:
An outer shell comprising a castable polyurethane elastomer and having a plurality of sides and inner surfaces, having at least one open side, and formed to enclose at least a portion of the mechanical device; and
an inner shell comprising polymeric foam adjacent the inner surfaces of the outer shell; wherein
the inner shell defines a space within which the mechanical device can be supported or constrained through contact with the inner shell.

2. The enclosure of claim 1, wherein the enclosure is formed to substantially enclose all but one side of the mechanical device.

3. The enclosure of claim 2, further including a foam panel having an inner surface and an outer surface, and comprising polymeric foam; wherein
the enclosure is formed to substantially enclose the mechanical device when the foam panel is configured to cover an open side of the enclosure.

4. The enclosure of claim 3, wherein the enclosure is formed to enclose a top and a plurality of sides of the mechanical device, and the foam panel is formed to allow its inner surface to support a bottom side of the mechanical device when the foam panel is positioned to cover the open side of the enclosure.

5. The enclosure of claim 3, wherein the foam panel further comprises a castable polyurethane elastomer panel having an inner surface and an outer surface, the inner surface of the polyurethane elastomer panel being adjacent the outer surface of the foam panel.

6. The enclosure of claim 2, wherein at least one side of the enclosure has one or more openings to allow one or more components of the mechanical device to protrude through the openings, the openings being sized to allow the enclosure to form an elastomeric seal around the protruding components.

7. The enclosure of claim 4, wherein the inner shell is formed to make contact with at least two lateral sides of the mechanical device in order to constrain lateral movement of the mechanical device.

8. The enclosure of claim 5, wherein the outer surface of the polyurethane elastomer panel is formed to make contact with a rigid plate.

9. The enclosure of claim 8, wherein the outer shell is sufficiently rigid to permit a flexible band or a spring clip to fasten the enclosure to the rigid plate.

10. The enclosure of claim 9, wherein the rigid plate is configured to be connected to a member for supporting the enclosure, the connection being made with an elastomeric bushing or mount.

11. The enclosure of claim 6, wherein at least one opening is sized to allow a component of the mechanical device to protrude through the opening, wherein the protruding component can be configured with a heat sink.

12. The enclosure of claim 5, wherein at least a portion of the space defined by the inner shell can remain empty when the mechanical device is installed within the enclosure.

13. The enclosure of claim 12, wherein the mechanical device is a pump module comprising a pump and motor.

14. The enclosure of claim 13, wherein the pump module can be vented at least partially within the enclosure.

15. The enclosure of claim 13, wherein the enclosure has an opening for an inlet tube and an opening for an outlet tube of the pump module, the inlet tube communicating with an inlet port of the pump module, and the outlet tube communicating with an outlet port of the pump module; wherein
the openings are sized to allow the enclosure to form elastomeric seals around the tubes.
